(19) United States
(12) Patent Application Publication
(10) Pub. No.: US 2019/0094010 A1
(43) Pub. Date: Mar. 28, 2019

(54) SYSTEMS AND METHODS FOR MEASURING VARIOUS PROPERTIES OF AN OBJECT

(71) Applicant: HEXAGON METROLOGY, INC., North Kingstown, RI (US)

(72) Inventor: David Demiter, Encinitas, CA (US)

(21) Appl. No.: 16/143,873

(22) Filed: Sep. 27, 2018

Related U.S. Application Data
(60) Provisional application No. 62/564,441, filed on Sep. 28, 2017.

(51) Int. Cl. G01B 11/00; G01B 11/24

(52) U.S. Cl. CPC G01B 11/005; G01B 11/24

(57) ABSTRACT

A first measuring device can be mounted to an end of an articulated arm coordinate measuring machine, and geometric coordinates of a surface of an object can be measured using the first measuring device. Then, a second measuring device can be mounted to the end of the articulated arm coordinate measuring machine and a second property of the object can be measured using the second measuring device, after the geometric coordinates have been measured.

### BACKGROUND

### Field

The present invention relates to coordinate measurement machines and, more particularly, to coordinate measurement machines with various types of scanners.

### Description of the Related Art

Rectilinear measuring systems, also referred to as coordinate measuring machines (CMMs) and articulated arm coordinate measuring machines, are used to generate highly accurate geometry information. In general, these instruments capture the structural characteristics of an object for use in quality control, electronic rendering and/or duplication. One example of a conventional apparatus used for coordinate data acquisition is a portable coordinate measuring machine (PCMM), which is a portable device capable of taking highly accurate measurements within a measuring sphere of the device. Such devices often include a probe mounted on an end of an arm that includes a plurality of arm members connected together by rotatable joints. The end of the arm opposite the probe is typically coupled to a moveable base. Often, the joints are broken down into singular rotational degrees of freedom, each of which is measured using a dedicated rotational transducer. During a measurement, the probe of the arm is usually moved manually by an operator to various points in the measurement sphere. At each measured point, the position of each of the joints must be determined at a given instant in time. Accordingly, each transducer outputs an electrical signal that varies according to the movement of the joint in that degree of freedom. Typically, the probe also generates a signal. These position signals and the probe signal are transferred through the arm to a recorder/analyzer. The position signals are then used to determine the position of the probe within the measurement sphere, and thus to also determine a position on an object being measured (for example, when contacted or otherwise sensed by the probe). See e.g., U.S. Pat. Nos. 5,829,148 and 7,174,651, which are incorporated herein by reference in their entireties.

Increasingly, PCMM's are used in combination with an optical or laser scanner. In such applications the optical or laser scanner typically includes an optics system, a laser or other light source, sensors, and electronics that are all housed in one box. The scanner box is then, in turn, coupled to the probe end of the PCMM (for example, to a side of the probe). In this manner, 2-dimensional and/or 3-dimensional data could be gathered with the laser scanner and combined with the position signals generated by the PCMM. See e.g., U.S. Pat. No. 7,246,030.

While such PCMM and laser scanner combinations have been useful. As mentioned above, the purpose of PCMM's is to take highly accurate measurements. Accordingly, there is a continuing need to improve the accuracy and capabilities of such devices.

### SUMMARY

One aspect of the present invention is the realization that such prior art systems suffer from a number of inefficiencies. For example, it may be desirable to use the PCMM to measure more than just geometric coordinates at a surface of an object, such as properties below the surface (for example, using ultrasound), data on the composition of the surface (for example, using spectral imaging or hyperspectral imaging), surface roughness, surface hardness, or other data. Further, it can be desirable to be able to associate this data with the corresponding coordinate data. Then, for example, a more complete description of the measured object can be generated, including various properties of the object beyond the geometric shape of the surface.

In one embodiment, a method of measuring various properties of an object is provided. A first measuring device can be mounted to an end of an articulated arm coordinate measuring machine, and three-dimensional coordinates of a surface of an object can be measured using the first measuring device. Then, a second measuring device can be mounted to the end of the articulated arm coordinate measuring machine and a second property of the object can be measured using the second measuring device, after the three-dimensional coordinates have been measured.

In another embodiment, a method of measuring various properties of an object can be provided. Three-dimensional coordinates of a surface of an object can be measured using a coordinate measuring device. A second measuring device can be mounted to the coordinate measuring device and a second property of the object can be measured using the second measuring device, after the three-dimensional coordinates have been measured.

In another embodiment, a device configured to measure a surface geometry of an object and at least one other property of the object can include a coordinate measuring device, a second measuring device, and one or more processors. The coordinate measuring device can be configured to measure three-dimensional coordinate data of a surface of an object by at least measuring a position and orientation of a portion of the coordinate measuring device. The coordinate measuring device can also include a mounting portion configured to receive a second measuring device such that the coordinate measuring device can measure a position and orientation of the second measuring device. The second measuring device can be mounted to the mounting portion and configured to measure a property of the object different from the three-dimensional coordinate data of the surface of the object at a plurality of locations. The one or more processors can be configured to use the three-dimensional coordinate data of the surface of the object and measured positions and orientations of the second measuring device to associate data collected by the second measuring device with appropriate three-dimensional coordinates.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed. In addition, the individual embodiments need not provide all or any of the advantages described above.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a perspective view of an embodiment CMM arm with a laser scanner;

FIG. 1A is a side view of the CMM arm of FIG. 1;

FIG. 1B is a top view of the CMM arm of FIG. 1;

FIG. 2 is a perspective view of a coordinate acquisition member of the CMM arm of FIG. 1;

FIG. 2A is a side view of the coordinate acquisition member of FIG. 2;

FIG. 2B is a top view of the coordinate acquisition member of FIG. 2;

FIG. 2C is a side cross-sectional view of the coordinate acquisition member of FIG. 2, at 2C-2C;

FIG. 3 is an exploded side view of the coordinate acquisition member of FIG. 2;

FIG. 3A is a back view of a non-contact coordinate detection device of FIG. 3, at 3A-3A;

FIG. 3B is a front view of a main body of a coordinate acquisition member of FIG. 3, at 3B-3B;

FIG. 4A is an exploded front-perspective view of the coordinate acquisition member of FIG. 3, with a locking piece also exploded;

FIG. 4B is an exploded rear-perspective view of the coordinate acquisition member of FIG. 4A;

FIGS. 5-9 are perspective views of various scanning devices attached to a CMM arm.

FIGS. 10 and 11 are flow charts indicating methods for measuring properties of an object.

FIG. 12 is an embodiment image displayed to a user indicating points that have been measured on an object.

### DETAILED DESCRIPTION

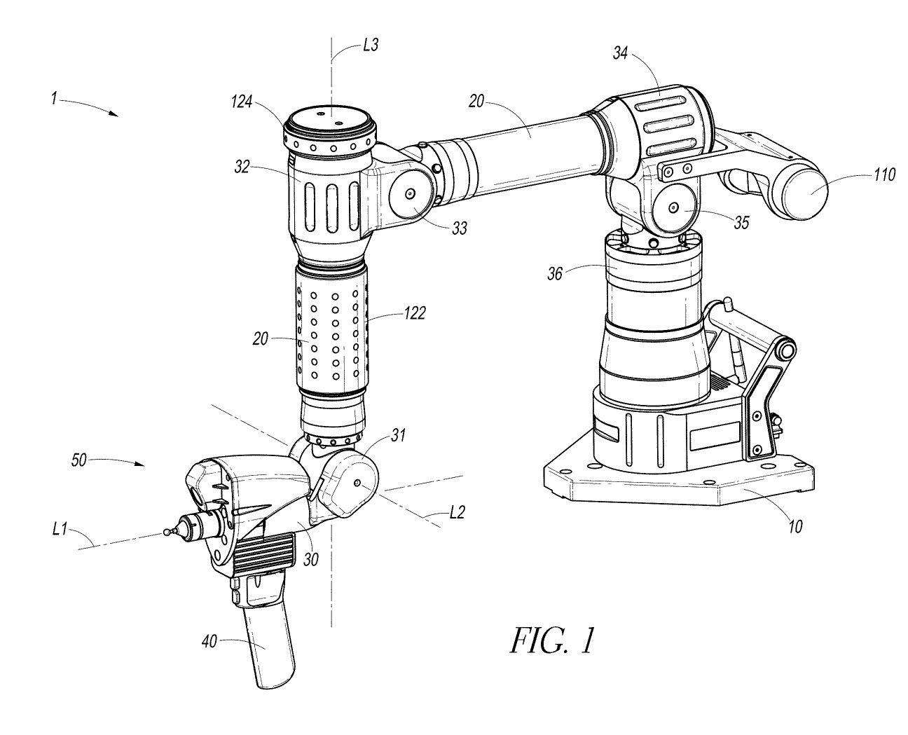

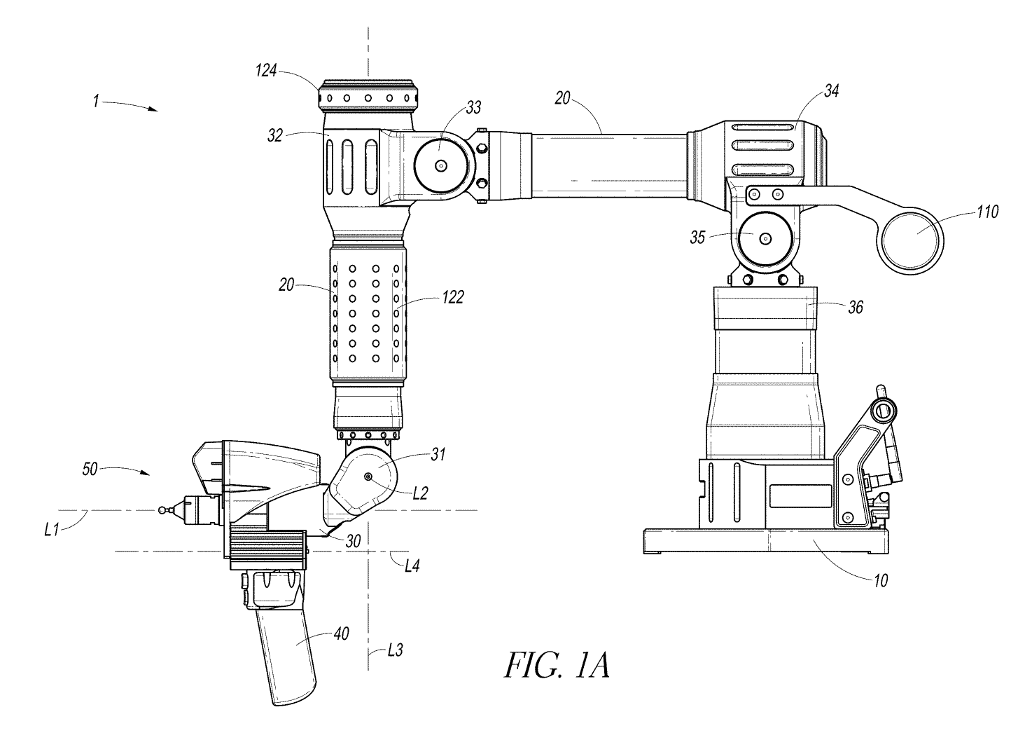

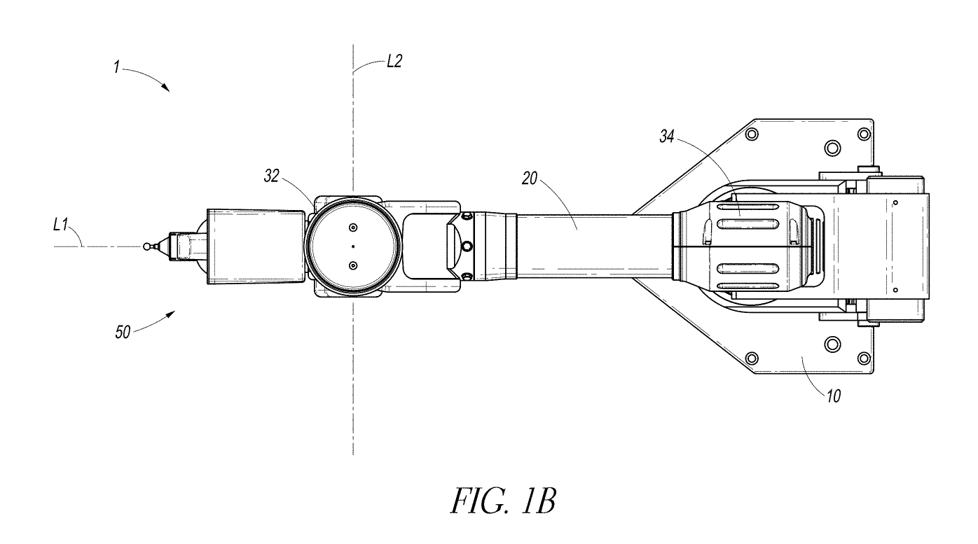

FIGS. 1-1B illustrate one embodiment of an articulated arm portable coordinate measuring machine (PCMM) 1. In the illustrated embodiment, the PCMM 1 comprises a base 10, a plurality of rigid arm members 20, a coordinate acquisition member 50 and a plurality of articulation members 30-36 connecting the rigid arm members 20 to one another as well as to the base 10 and the coordinate acquisition member 50. Each articulation member 30-36 is configured to provide a joint imparting one or more rotational and/or angular degrees of freedom. Through the various articulation members 30-36, the PCMM 1 can be aligned in various spatial orientations thereby allowing fine positioning and orientating of the coordinate acquisition member 50 in three dimensional space. The coordinate acquisition member 50 can then be used to measure one or more specific locations such as geometric or three-dimensional data on a surface of an object.

The position of the rigid arm members 20 and the coordinate acquisition member 50 may be adjusted using manual, robotic, semi-robotic and/or any other adjustment method. In one embodiment, the PCMM 1, through the various articulation members 30-36, is provided with seven rotary axes of movement. It will be appreciated, however, that there is no strict limitation to the number of axes of movement that may be used, and fewer or additional axes of movement may be incorporated into the PCMM design.

In the embodiment PCMM 1 illustrated in FIG. 1, the articulation members 30-36 can be divided into two functional groupings based on their operation, namely: 1) those articulation members 30, 32, 34, 36 which allow the swiveling motion associated with a specific transfer member (hereinafter, “swiveling joints”), and 2) those articulation members 31, 33, 35 which allow a change in the relative angle formed between two adjacent members or between the coordinate acquisition member 30 and its adjacent member (hereinafter, “hinge joints”). The swiveling joints can optionally provide ranges of motion of up to at least 360 degrees, and can further optionally provide infinite rotation (such that they can rotate continuously in the same direction without stopping). The hinge joints, like normal hinges, usually have a range of motion near to but less than 360 degrees to allow sufficient flexibility in the arm to reach a wide variety of points at different angles. While the illustrated embodiment includes four swiveling joints and three hinge joints positioned to create seven axes of movement, it is contemplated that in other embodiments, the number of and location of hinge joints and swiveling joints can be varied to achieve different movement characteristics in a PCMM. For example, a substantially similar device with six axes of movement could simply lack the swivel joint 30 between the coordinate acquisition member 50 and the adjacent articulation member 20. In still other embodiments, the swiveling joints and hinge joints can be combined and/or used in different combinations.

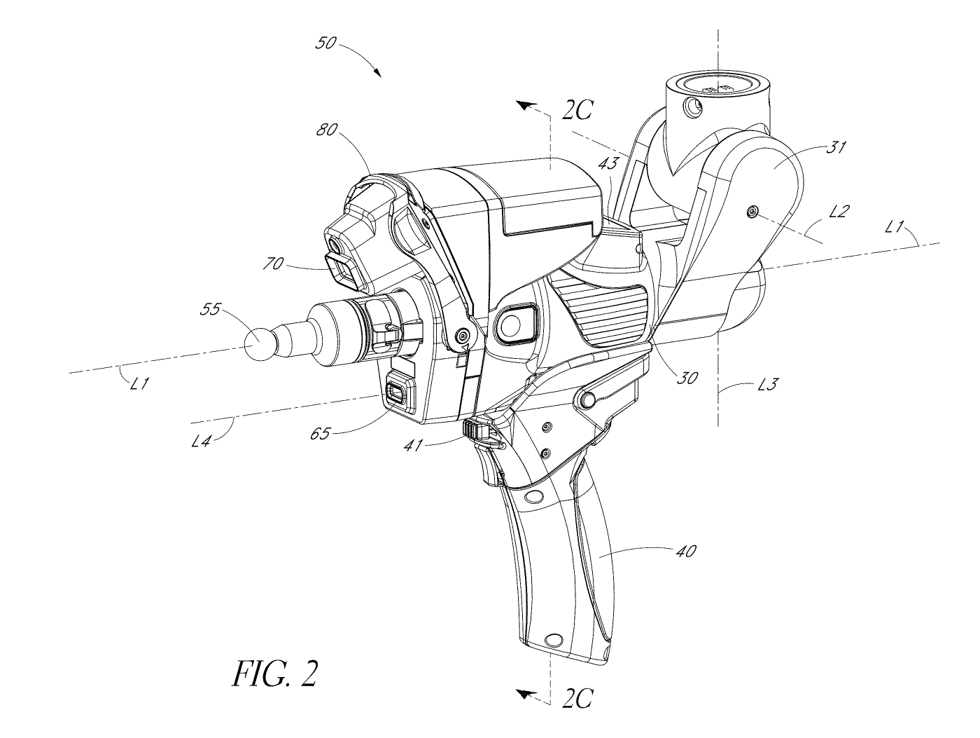

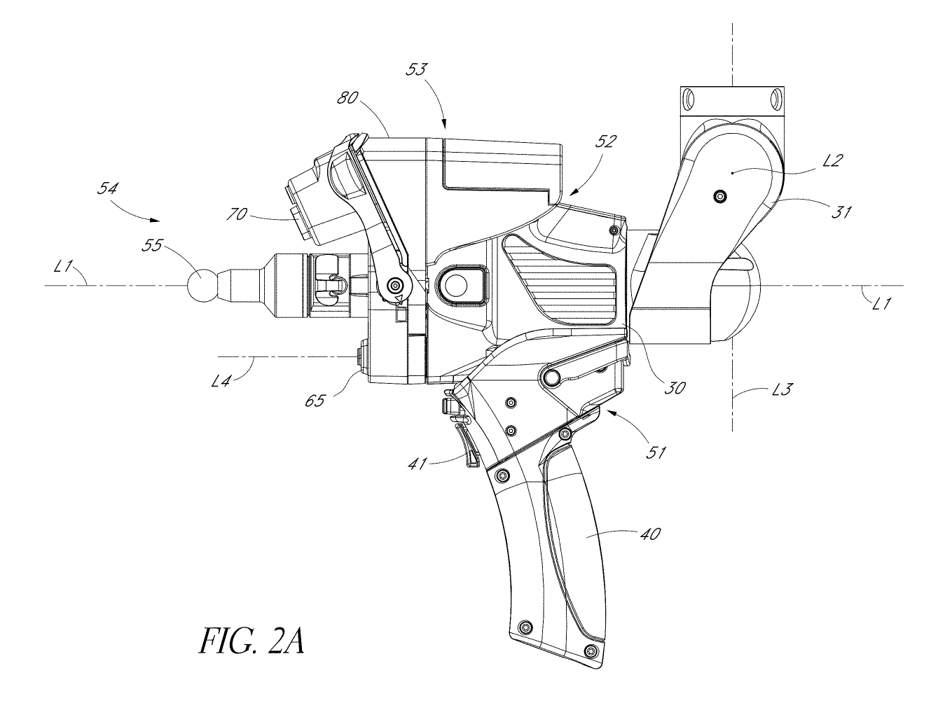

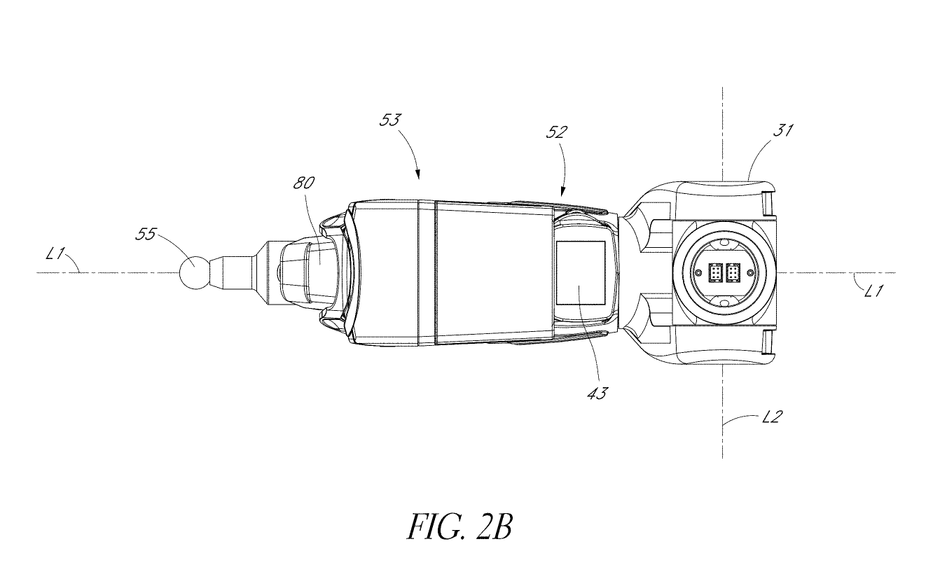

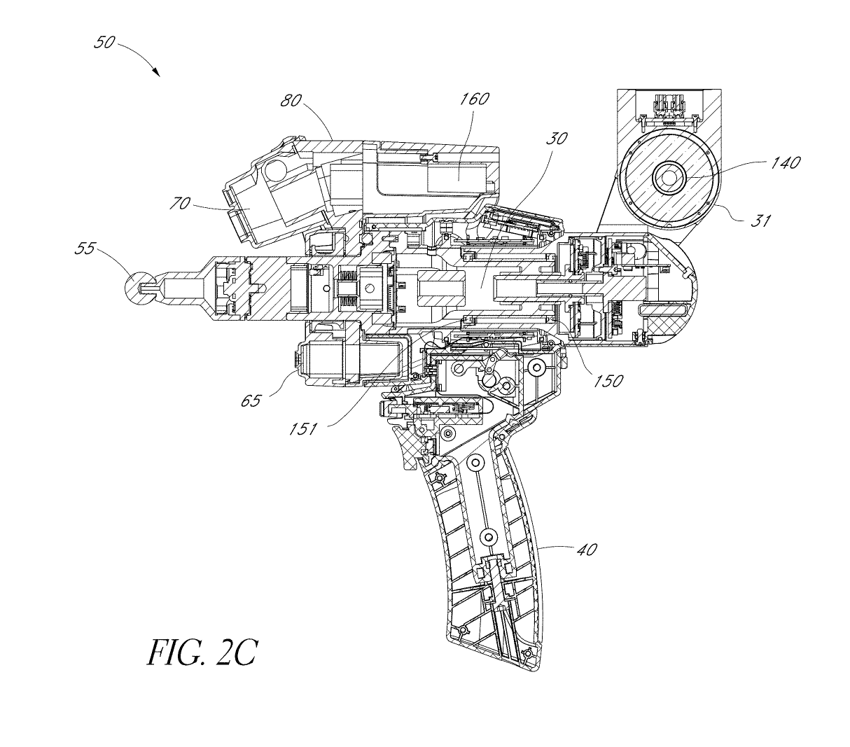

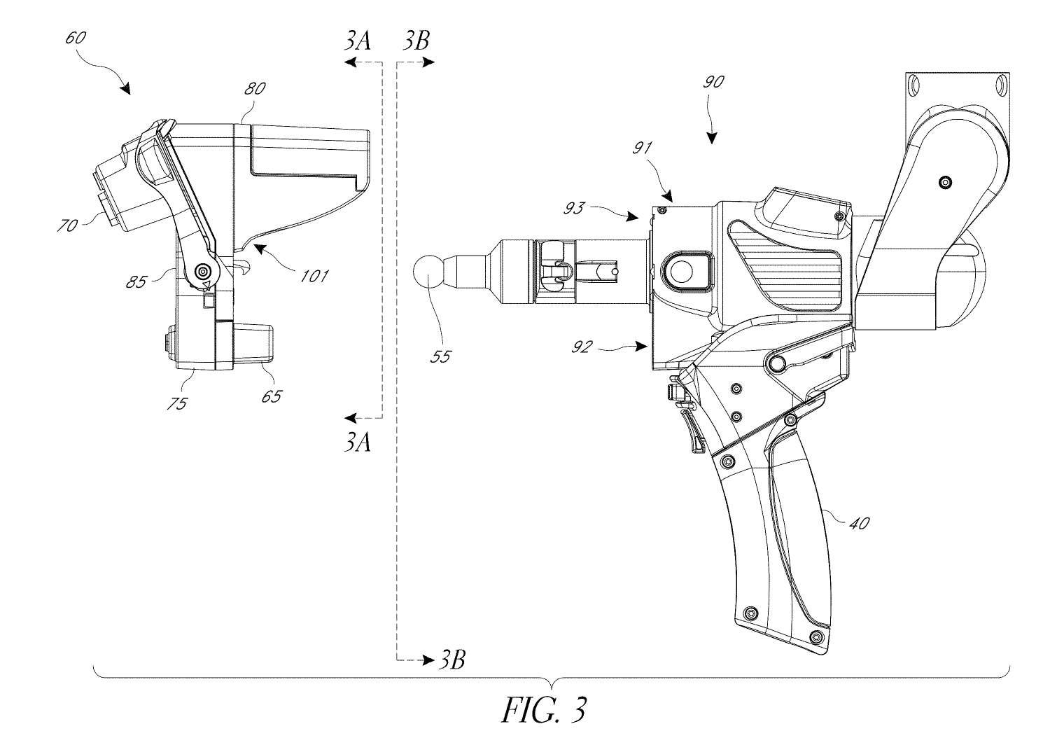

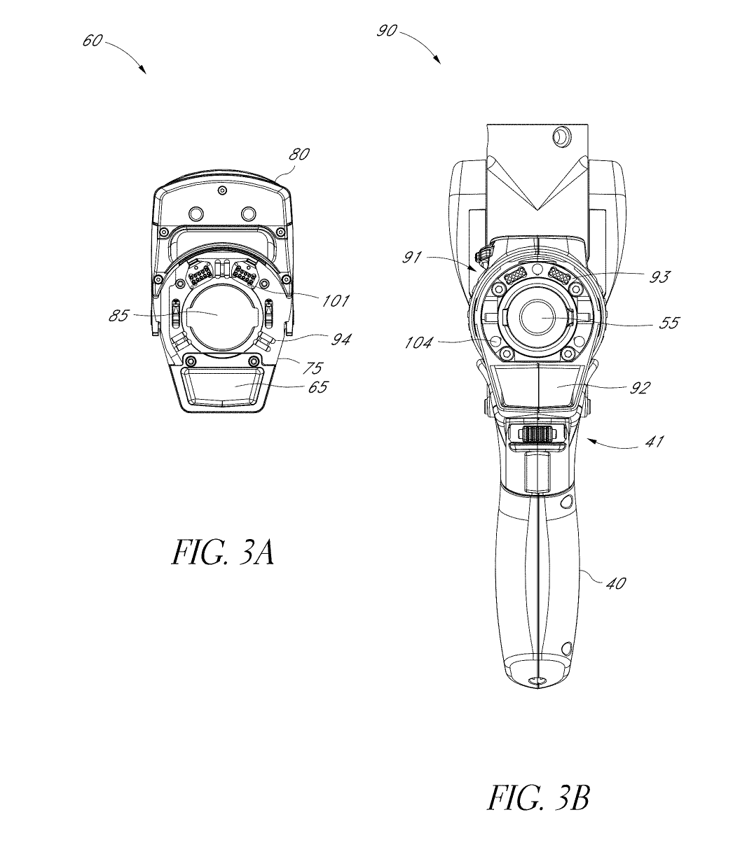

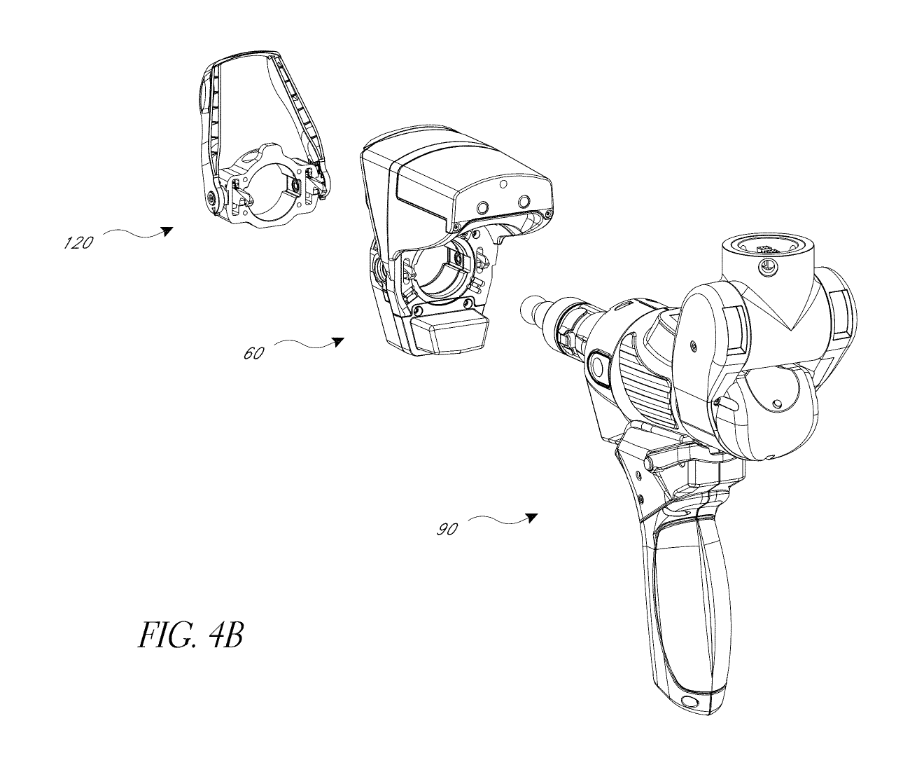

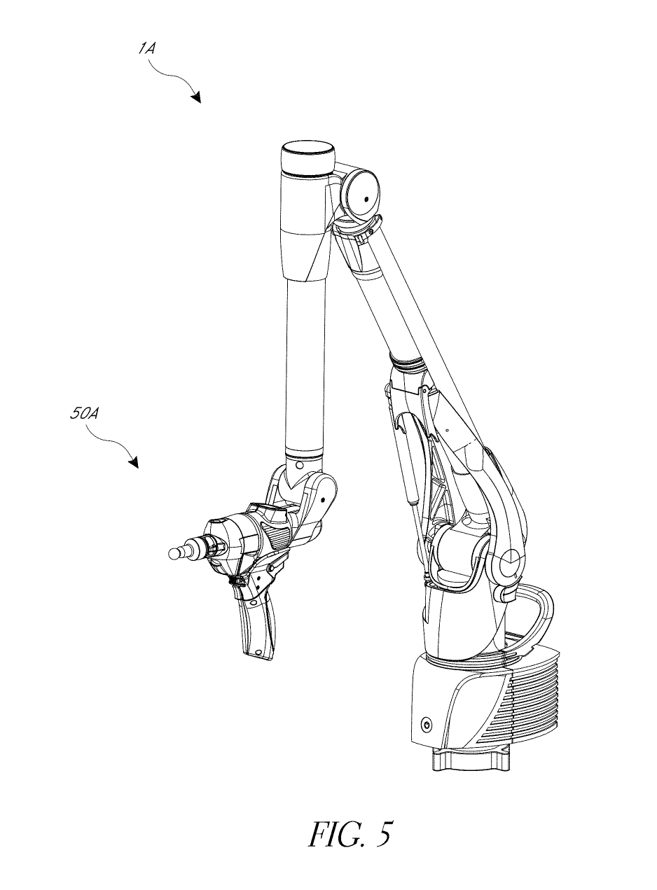

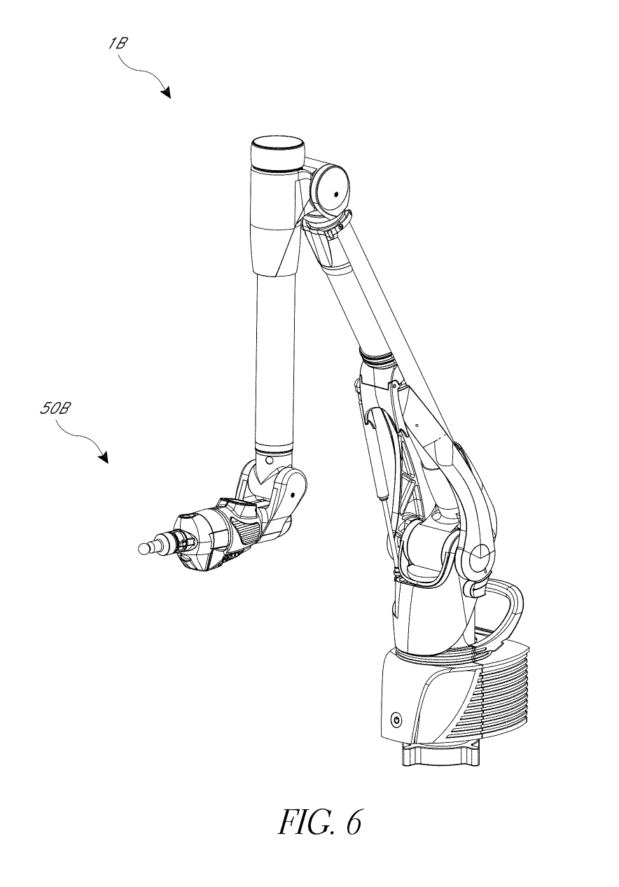

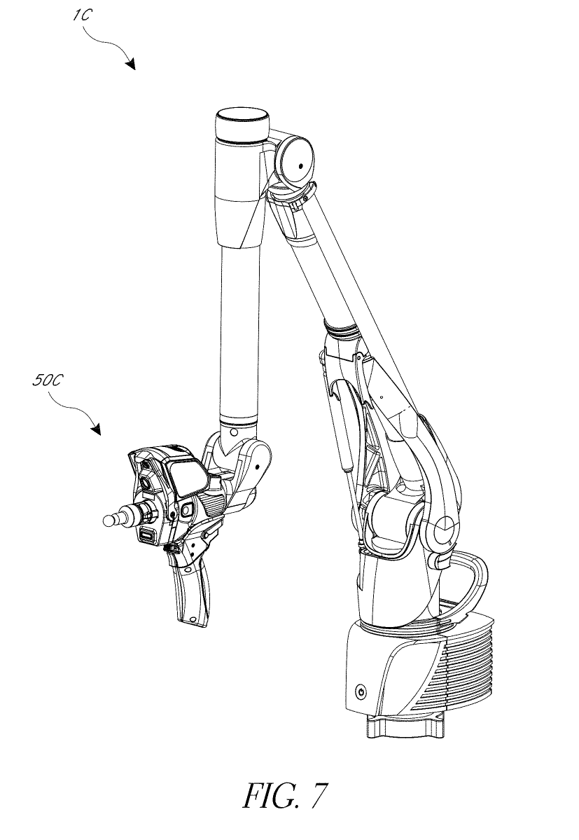

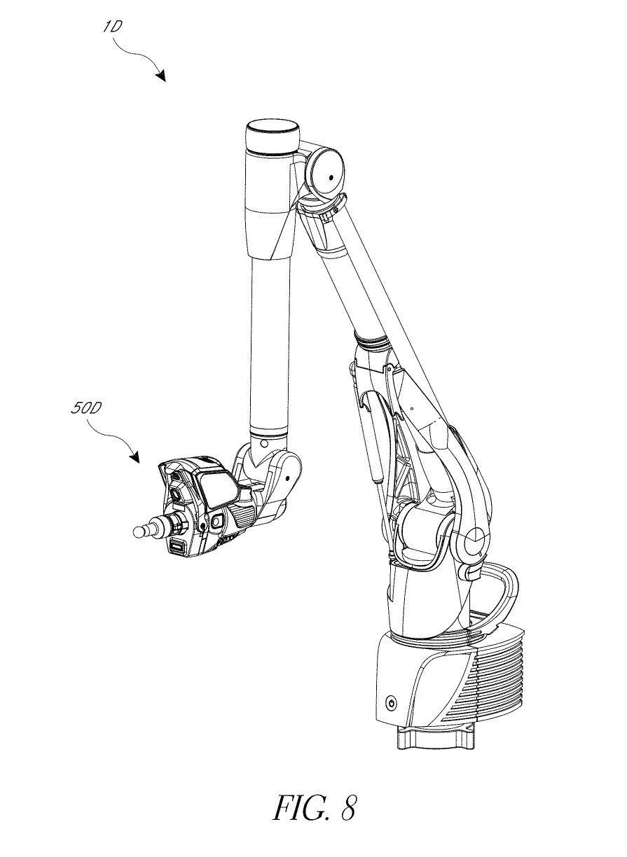

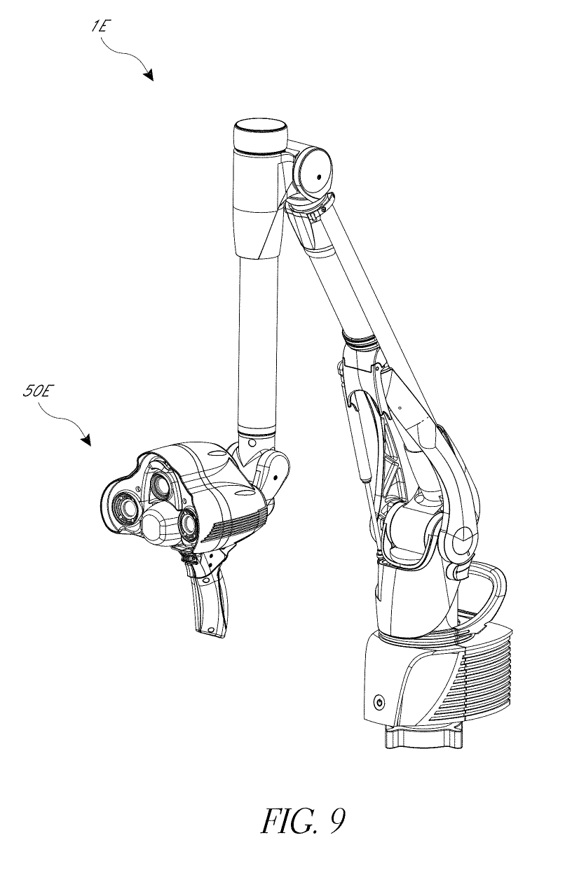

The coordinate acquisition member 50 optionally includes a contact sensitive member or probe 55 (depicted as a hard probe, which can be removed or otherwise not included if only non-contact scanning is intended without reducing the functionality of the other components described herein) configured to contact the surfaces of a selected object and generate geometric data of the surface such as three-dimensional coordinate data on the basis of probe contact, as depicted in FIGS. 2-3. This coordinate data can be generated, for example, in combination with other sensors on the articulated arm indicating a position of the arm and thus a position of the probe. In the illustrated embodiment, the coordinate acquisition member 50 also includes a non-contact scanning and detection component that does not necessarily require direct contact with the selected object to acquire three-dimensional coordinate data. As depicted, the non-contact scanning device includes a non-contact coordinate detection device 60 (shown as a laser coordinate detection device/laser scanner) that may be used to obtain three-dimensional coordinate data without direct object contact. It will be appreciated that various coordinate acquisition member configurations including: a contact-sensitive probe, a non-contact scanning device, a laser-scanning device, a structured light scanner, a probe that uses a strain gauge for contact detection, a probe that uses a pressure sensor for contact detection, a device that uses an infrared beam for positioning, and a probe configured to be electrostatically-responsive may be used for the purposes of coordinate acquisition. Further, in some embodiments, a coordinate acquisition member 50 can include one, two, three, or more than three coordinate acquisition mechanisms. Other scanning devices can also be used, such as ultrasound scanners, x-ray scanners, or other scanners that can measure geometric properties beneath the surface of an object being measured. Thus, although in the following description a non-contact coordinate detection device 60 is shown mounted on the PCMM 1, other devices that do not measure coordinates on a surface or that do not measure coordinates at all can also be used. FIGS. 5-9 depict a variety of different measuring and scanning devices mounted to a PCMM. For example, FIG. 5 depicts a PCMM 1A with a contact probe 50A and a pistol grip handle. FIG. 6 depicts a PCMM 1B with a contact probe 50B without a pistol grip handle. FIG. 7 depicts a PCMM 1C with a contact probe and a laser scanner 50C and a pistol grip handle. FIG. 8 depicts a PCMM 1D with a contact probe and a laser scanner 50D without a pistol grip handle. FIG. 9 depicts a PCMM 1E with a structured light scanner 50E and a pistol grip handle.

Even further, scanning devices that do not measure surface geometry data, but instead measure some non-geometric property of the object or geometric features below the surface of the object, can also be included, such as spectral and hyperspectral imagers, roughness sensors, hardness sensors, ultrasound sensors, and eddy current sensors. The non-geometric properties can include color, chemical properties, roughness, hardness, and features such as voids and cracks below the surface. Notably, the non-geometric properties can be different from properties that can be determined form a standard camera, such as color, which might already be detected by a camera on the non-contact coordinate detection device 60. The data acquired from these non-geometric sensors can still be associated with a geometric position using the known position and orientation of the PCMM 1 (and thus the scanning device), as well as the known geometry of the surface of the object (which can be measured separately). For example, a pixel on a spectral two-dimensional image can be associated with a measured three-dimensional position on the object using a known position of the scanning device and a known shape and position of the object. The pixel in the image can be known to correspond with a point somewhere along a ray starting at a central point of a camera or other sensor capturing the image and extending at an angle determined by the location of the pixel and the orientation of the sensor. A nearest three-dimensional coordinate on the object (as potentially also measured by the PCMM 1) intersected by the ray can be determined to be associated with the pixel. Similar techniques can be used with other measuring devices that generate a plurality of data over a two-dimensional area (for example, as two-dimensional images). Associating such non-geometric data of the object at a plurality of locations with specific three-dimensional coordinates on the object would be more difficult without also having measured the geometry of the object directly.

Similarly, data measured at one location at a time can be determined using the PCMM 1 in a manner similar to use with a contact sensitive member 55. For example, an ultrasound sensor or eddy current sensor can record data, and that data can be associated with a three dimensional location on the object measured according to the location and position of the PCMM 1.

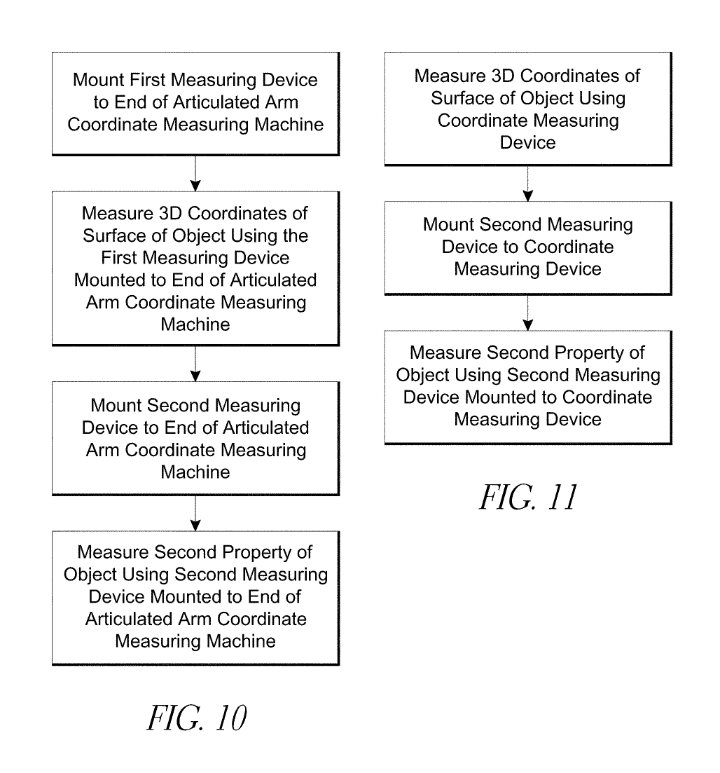

In one example, depicted in FIG. 10, a geometric measuring device such as a contact probe or a non-contact scanning device can be mounted to the PCMM 1 and be used to measure three-dimensional coordinate data on a surface of an object. Then, that geometric measuring device can be removed and replaced with a second scanning device, such as a device that measures a non-geometric property of the object, and a second property of the object can be measured with the second scanning device. This process can be repeated for a third scanning device, fourth scanning device, and so on. Further, additional scanning devices can optionally be used to measure three-dimensional coordinate data on a surface of the object. For example, first and second scanning devices might both measure three-dimensional coordinate data on the surface (such as with a structured light scanner and then a laser scanner), and then non-geometric properties of the surface can be measured.

Notably, in some embodiments it may be possible to mount multiple scanning devices on the PCMM 1 simultaneously, such that the step of replacing one with the other is not necessary. Further, it may be desirable to use multiple devices for measuring geometric properties, such as if one device measures more accurately and another device measures less-accurately but more quickly. In this way, a user can measure a large area less precisely, and a small area more precisely, without needing to change what devices are mounted on the PCMM 1.

Using these various scanning devices, a more complete model of the measured object can be generated. For example, whereas previously the measured data might only indicate a geometry on a surface of the object, now a full geometric description of the object can be created, including sub-surface cracks, open spaces, discontinuities in material, or other characteristics below the surface. Features below the surface can be measured, for example, with an ultrasound sensor, an eddy current sensor, or an x-ray sensor that can be mounted on the PCMM 1. Further, additional properties can be included in the model of the object, such as material properties, textures, hardness, colors, and other properties that can be measured with additional sensors.

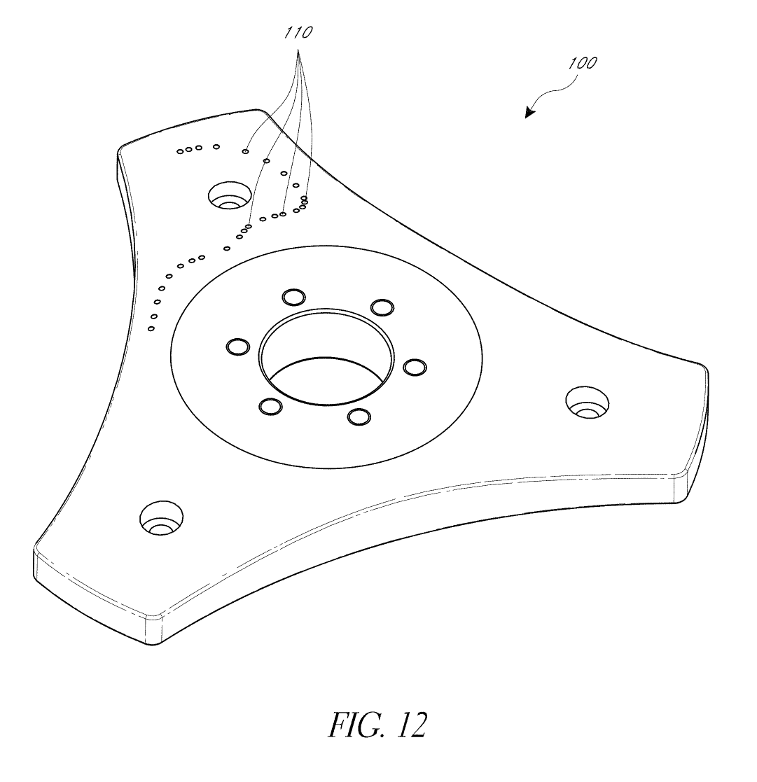

It may be difficult for an operator of the device to recognize if the entire object has been measured, particularly if some measurements are being made beneath the surface of the object. In some embodiments, the device can first be used to measure geometric coordinates on the surface of the object to create a model of the surface of the object sufficient to also determine the extent of an interior space of the object. This geometry data can then be used by a processor on the PCMM 1 (such as on the coordinate acquisition member 50, the specific scanning device that is attached, or a base of the PCMM) or on a separate computing device in electronic communication with the PCMM, to create a model of the interior of the object. This model can then be used by the processor to indicate to an operator of the PCMM 1 where additional measurements need to be taken to measure a particular property across all of the surface of an object (and optionally including all of an interior of the object) or all of a desired portion of the object. The processor optionally can also indicate when measurements of the entire object or a desired portion of the object has been completed. FIG. 12 depicts an image that can be displayed to a user, showing points 110 that have been measured on an embodiment object 100, where the object's shape can be determined based on measured three-dimensional coordinates.

For example, in some embodiments the PCMM 1 can include a display 43 (or be in communication with a separate display) that can show to an operator of the PCMM where additional measurements need to be taken, such as by indicating a position beneath the surface of the object with a particular symbol or color overlaid on an image of the object being measured. In further embodiments, the display can suggest a desired position for the PCMM 1 to be in to measure any portions of the object that have not been measured, showing the suggested position on the display. To further guide an operator of the PCMM 1 to a desired measurement position, the display can optionally show the current position of the PCMM 1 in addition to the desired position on the same screen, highlighting the remaining movement necessary. Such displays of the desired position can be particularly helpful when measuring characteristics below the surface of the object because the optimal position to measure on the surface might not be immediately apparent to a user. When measurement of the entire object (or a desired portion of the object) is complete, a signal can be provided to the user such as a signal on the display or an auditory signal. Similarly, the display can show where measurements have already been taken. These methods can also be used for taking measurements on the surface of the object, and are not limited to measurements beneath the surface of an object.

Thus, in addition to measuring coordinate data on a surface of the object, the PCMM 1 can also measure one or more additional properties of the object. Further, as indicated, these can optionally be done sequentially, such as beginning with geometric coordinates on the surface, then geometric coordinates beneath the surface, and then one or more additional measurements. Other sequences are also possible, such as measuring various additional (non-geometric coordinate) properties of the surface prior to measuring geometric coordinates beneath the surface.

Similar measurements can also be made without an articulated arm portable coordinate measuring machine, instead using a general coordinate measuring device as depicted in FIG. 11. For example, in some embodiments a laser tracker (and associated retroreflectors) can be used with the various scanning devices in a manner similar to the PCMM 1 to determine a position and orientation of a scanning device. The scanning device can have one or more retroreflectors that can be detected using a laser whose orientation can be adjusted to follow the retroreflectors. Light emitted by the laser and reflected by the retroreflectors can be detected and used to determine a location of the scanning device. Variations on the laser tracker systems can also be used, such as using independent light sources or other visually-identifiable objects in place of the laser and retroreflectors. The laser tracker can be used to measure 3D coordinates of a surface of the object, and the second measuring device (such as a scanning device) can be used to measure a second property. In other embodiments, a geometry-measuring scanning device can be mounted with another scanning device, and the geometry-measuring scanning device can determine its own location by comparing currently measured coordinates with previously measured coordinates in the same area, identifying individual features present in both sets of measured coordinates, and using the different location and orientation of the individual features in each set of coordinates to determine the distance and orientation of the features relative to the scanning device. Other coordinate measuring devices can also be used to determine a three-dimensional surface geometry of the object.

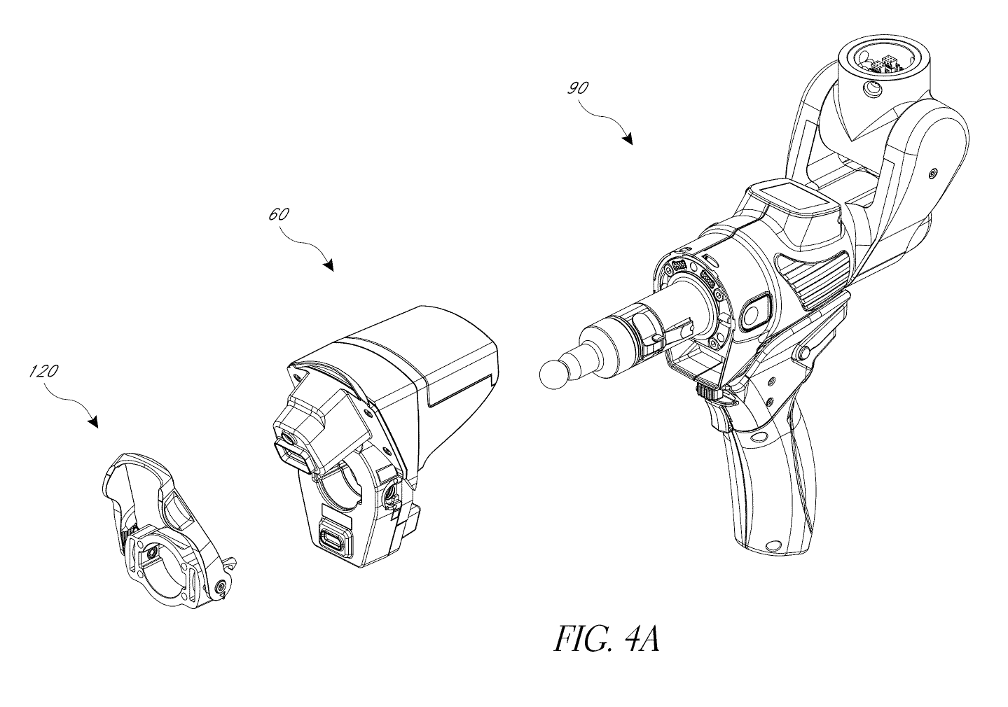

With particular reference to FIGS. 3, 3A, 3B, 4A, and 4B, in various embodiments of the PCMM 1, the various measuring devices can be configured to be manually disconnected and reconnected from the PCMM 1 such that an operator can change scanning devices without specialized tools. Thus, an operator can quickly and easily remove one measuring device and replace it with another measuring device (such as a coordinate acquisition device, or a non-geometric scanning device). Such a connection may comprise any quick disconnect or manual disconnect device. This rapid connection capability of a coordinate acquisition device can be particularly advantageous in a PCMM 1 that can be used for a wide variety of measuring techniques in a relatively short period of time. Although, as depicted, only the laser coordinate detection device 60 is removed, in some embodiments the contact sensitive member 55 can also be removed and replaced in a similar manner.

As shown in FIG. 2, the coordinate acquisition member 50 can also include buttons 41, which are configured to be accessible by an operator. By pressing one or more of the buttons 41 singly, multiply, or in a preset sequence, the operator can input various commands to the PCMM 1. In some embodiments the buttons 41 can be used to indicate that a coordinate reading is ready to be recorded. In other embodiments the buttons 41 can be used to indicate that the location being measured is a home position and that other positions should be measured relative to the home position. In other embodiments the buttons 41 may be used to record points using the contact sensitive member 55, record points using the non-contact coordinate detection device 60, record data using a non-geometric scanning device, or to switch between the devices. In other embodiments, the buttons 41 can be programmable to meet an operator's specific needs. The location of the buttons 41 on the coordinate acquisition member 50 can be advantageous in that an operator need not access the base 10 or a computer in order to activate various functions of the PCMM 1 while using the coordinate acquisition member 50. This positioning may be particularly advantageous in embodiments of PCMMs having arm members 20 that are particularly long, thus placing the base 10 out of reach for an operator of the coordinate acquisition member 50 in most positions. In some embodiments of the PCMM 1, any number of operator input buttons (e.g., more or fewer than two) can be provided. Advantageously, as depicted the buttons 41 are placed on the handle 40 in a trigger position, but in other embodiments it may be desirable to place buttons in other positions on the coordinate acquisition member 50 or anywhere on the PCMM 1, such as along a barrel of the last axis L1. Other embodiments of a PCMM can include other operator input devices positioned on the PCMM or the coordinate acquisition member 50, such as switches, rotary dials, touch screens, or touch pads in place of, or in addition to operator input buttons. Further, in some embodiments input devices can be included on the scanning devices (such as the non-contact coordinate detection device 60) that can be mounted to and removed from the PCMM 1. These input devices can optionally be specific to their associated scanning device.

With particular reference to FIG. 1, the base 10 can be coupled to a work surface through a magnetic mount, a vacuum mount, bolts or other coupling devices, or can instead rest on the work surface. Additionally, the base 10 can include various electrical interfaces such as plugs, sockets, or attachment ports. The attachment ports can provide connectability between the PCMM 1 and a USB interface for connection to a processor such as a general purpose computer, an AC power interface for connection with a power supply, or a video interface for connection to a monitor. The PCMM 1 can also be configured to have a wireless connection with an external processor or general purpose computer such as by a WiFi connection, Bluetooth connection, RF connection, infrared connection, or other wireless communications protocol to a general purpose computer, smartphone, tablet, or other device. These can also optionally provide for wireless communication with the various scanning devices that can be mounted to the PCMM 1 opposite from the base such as geometric and non-geometric scanning devices. The various electrical interfaces or attachment ports can be specifically configured to meet the requirements of a specific PCMM 1.

With continued reference to FIG. 1, the arm members 20 are preferably constructed of hollow generally cylindrical tubular members so as to provide substantial rigidity to the members 20. The arm members 20 can be made of any suitable material which will provide a substantially rigid extension for the PCMM 1. The arm members 20 preferably define a double tube assembly so as to provide additional rigidity to the transfer members 20. Furthermore, it is contemplated that the arm members 20 in various other embodiments can be made of alternate shapes such as those comprising a triangular or octagonal cross-section.

In some embodiments, it can be desirable to use a composite material, such as a carbon fiber material, to construct at least a portion of the arm members 20. In some embodiments, other components of the PCMM 1 can also comprise composite materials such as carbon fiber materials. Constructing the arm members 20 of composites such as carbon fiber can be particularly advantageous in that the carbon fiber can react less to thermal influences as compared to metallic materials such as steel or aluminum. Thus, coordinate measuring can be accurately and consistently performed at various temperatures. In other embodiments, the arm members 20 can comprise metallic materials, or can comprise combinations of materials such as metallic materials, ceramics, thermoplastics, or composite materials. Also, as will be appreciated by one skilled in the art, many of the other components of the PCMM 1 can also be made of composites such as carbon fiber. Presently, as the manufacturing capabilities for composites are generally not as precise when compared to manufacturing capabilities for metals, generally the components of the PCMM 1 that require a greater degree of dimensional precision are generally made of a metals such as aluminum. It is foreseeable that as the manufacturing capabilities of composites improved that a greater number of components of the PCMM 1 can be also made of composites.

With continued reference to FIG. 1, some embodiments of the PCMM 1 may also comprise a counterbalance system 110 that can assist an operator by mitigating the effects of the weight of the PCMM. In some orientations, when the arm members 20 are extended away from the base 10, the weight of the arm members can create difficulties for an operator. Thus, a counterbalance system 110 can be particularly advantageous to reduce the amount of effort that an operator needs to position the PCMM 1 for convenient measuring. In some embodiments, the counterbalance system 110 can comprise resistance units (not shown) which are configured to ease the motion of the arm members 20 without the need for heavy weights to cantilever the arm members. It will be appreciated by one skilled in the art that in other embodiments simple cantilevered counterweights can be used in place or in combination with resistance units. Further, although as depicted there is only one counterbalance system 110 unit, in other embodiments there can be more.

In some embodiments, the resistance units can comprise hydraulic resistance units which use fluid resistance to provide assistance for motion of the arm members 20. In other embodiments the resistance units may comprise other resistance devices such as pneumatic resistance devices, or linear or rotary spring systems.

The position of the contact sensitive member 55 in space at a given instant can be calculated by knowing the length of each rigid arm member 20 and the specific position of each of the articulation members 30-36. Each of the articulation members 30-36 can be broken down into a singular rotational degree of motion, each of which is measured using a dedicated rotational transducer. Each transducer outputs a signal (e.g., an electrical signal), which varies according to the movement of the articulation member in its degree of motion. The signal can be carried through wires or otherwise transmitted to the base 10 (or another processor associated with the PCMM 1). From there, the signal can be processed and/or transferred to a computer for determining the position of the coordinate acquisition member 50 and its various parts in space.

In one embodiment, the transducer can comprise an optical encoder. In one example, each encoder measures the rotational position of its axle by coupling its movement to a pair of internal wheels having successive transparent and opaque bands. In such embodiments, light can be shined through the wheels onto optical sensors which feed a pair of electrical outputs. As the axle sweeps through an arc, the output of the analog encoder can be substantially two sinusoidal signals which are 90 degrees out of phase. Coarse positioning can occur through monitoring the change in polarity of the two signals. Fine positioning can be determined by measuring the actual value of the two signals at the instant in question. In certain embodiments, maximum accuracy can be obtained by measuring the output precisely before it is corrupted by electronic noise. Additional details and embodiments of the illustrated embodiment of the PCMM 1 can be found in U.S. Pat. No. 5,829,148, the entirety of which is hereby incorporated by reference herein. Other types of encoders can also be used, such as absolute encoders as described in U.S. Patent Pub. No. 2011/0112786 or spherical encoders as described in U.S. Pat. No. 7,743,524, the entirety of each incorporated by reference herein.

With reference to FIGS. 1, 1A, and 1B, in some embodiments, the PCMM 1 can comprise one or more rotatable grip assemblies 122, 124. In the illustrated embodiment, the PCMM 1 can comprise a lower rotatable grip assembly 122 and an upper rotatable grip assembly 124. Advantageously, having a lower rotatable grip assembly 122 and an upper rotatable grip assembly 124 disposed on a last transfer member 21, allows the operator to easily use both hands in positioning the PCMM 1. In other embodiments, the PCMM 1 can comprise one, or more than two rotatable grips. Additional details of the grip assemblies can be found in U.S. Pat. No. 7,779,548, the entirety of which is hereby incorporated by reference herein

While several embodiments and related features of a PCMM 1 have been generally discussed herein, additional details and embodiments of PCMMs can be found in U.S. Pat. Nos. 5,829,148, 7,174,651, and 8,112,896 the entirety of these patents being incorporated by reference herein.

As depicted in FIG. 1, the PCMM can include a coordinate acquisition member 50 at a distal end of its arm. FIGS. 2-3 depict a similar coordinate acquisition member 50, in more detail. As shown, the coordinate acquisition member 50 can include a contact sensitive member 55 and a scanning device 60 facing a front end 54. The coordinate acquisition member 50 can further attach to a handle 40 at a lower end 51 and the PCMM 1 at a rear end 52. The coordinate acquisition member 50 can further include a top end 53. At the rear end 52, the coordinate acquisition member 50 can further include a data connection (not shown) with the hinge 31, such as a slip ring connection, a direct wire, or some other connection. This can allow data transfer between the coordinate acquisition member 50 and the PCMM 1. The PCMM 1 can include similar data transfer elements along its arm, allowing data transmission between the coordinate acquisition member 50 and the base 10, or any peripheral computing medium external to the PCMM arm. Similar data transfers can also be provided through a wireless connection.

The scanning device 60 can include a light source 65 (depicted as a laser) and an optical sensor 70 (depicted as a camera), and can acquire positional data by methods such as triangulation. The laser or light source 65 can create an illuminated laser plane including a laser line L4. The camera 70 can be displaced from the laser plane and further be non-parallel to the laser plane. Accordingly, the camera 70 will view points illuminated by the laser as higher or lower in an image captured by the camera 70, depending on their position further or closer to the laser 65. Similarly, the camera 70 will view points illuminated by the laser as being either further to the left or the right, according to their actual position relative to the laser 65. Comparing the geometric relationship between the position and orientation of the laser 65 and the camera 70 will allow one of skill in the art to appropriately translate the position of the image of the laser-illuminated point in the image captured by the camera 70 to an actual three-dimensional position in space in relation to the position of the coordinate acquisition member 50 itself.

In other embodiments, the light source 65 can emit a 2-dimensional pattern such as a structured light pattern. The camera can then acquire an image of this pattern on the object being measured, and use variations between the known pattern projected, the pattern acquired in the image, and the relative position and orientation of the camera 70 and the light source 65 to determine geometric coordinates on the object. A further description of such systems can be found, for example, in Geng, Jason, DLP-based Structured Light 3D Imaging Technologies and Applications, Proc. SPIE 7932, Emerging Digital Micromirror Device Based Systems and Applications III, 79320B (11 Feb. 2011); doi: 10.1117/12.873125, which is incorporated by reference in its entirety.

In FIG. 1, a plurality of the axes of movement are marked according to their proximity to the coordinate acquisition member 50. As depicted, the coordinate acquisition member 50 can pivot about a last axis of rotation L1 on a swivel 30. The last axis of rotation L1 and the swivel 30 are more clearly depicted in FIGS. 2A and 2C. As shown, the scanning device 60 mounts bearings 150, 151 at an end of the PCMM arm 1. The orientation and position of the bearings 150, 151 can substantially define the last axis L1. Thus, the scanning device 60 can rotate about the last axis L1, independent of the contact sensitive member (depicted as a probe) 55. In some embodiments, the contact sensitive member 55 is not rotatable, reducing potential error from any eccentricity between the contact sensitive member 55 and the last axis L1. The swivel 30 can rotate about a second to last axis of rotation L2 at the end of the last rigid transfer member 21 on a hinge joint 31. Like the bearings 150, 151 and the last axis L1, the second to last axis L2 can be substantially defined by a hinge shaft 140. As depicted, the last axis L1 can also be considered a roll axis, and the second to last axis can also be considered a pitch axis. Similarly, rotation about a third to last axis L3 can be considered a yaw axis.

The handle 40 can also generally comprise a pistol-grip style, which can further include ergonomic grooves corresponding to human fingers (not shown). The handle can also have a generally central axis. Optionally, within the handle 40, a battery can be held. In some embodiments the handle 40 can include a sealed battery, as described in U.S. Publication No. 2007/0256311A1, published Nov. 8, 2007, which is incorporated by reference herein in its entirety. Further, the battery can insert through the bottom of the handle 40. In other embodiments, the battery can insert through the top of the handle 40, and the handle 40 can release from the coordinate acquisition member 50 to expose an opening for battery insertion and removal. The battery can be provided to power the scanning devices, rotational motors about one of the articulation members 30-36, and/or other types of probes or devices. This can reduce current draw through the arm, decrease overall power requirements, and/or reduce heat generated in various parts of the arm.

Data can be transmitted wirelessly to and from either the coordinate acquisition member 50 or the scanning device 60 and the base of the PCMM 1 or to an external device such as a computer. This can reduce the number of internal wires through the PCMM 1. It can also reduce the number of wires between the PCMM 1 and the computer.

Above the handle 40, the coordinate acquisition member 50 can include a main body 90, best depicted in FIG. 3. The main body 90 can connect directly to the hinge 31 at the rear end 52 of the coordinate acquisition member 50. The main body 90 can further hold the contact sensitive member 55. In preferred embodiments, the main body 90 can even further hold the contact sensitive member 55 in near alignment with the swivel 30, such that an axis of the contact sensitive member 55 extends near the last axis L1 of the swivel 30. In some embodiments, the axis of the contact sensitive member 55 can pass through the last axis L1 of the swivel 30. In other embodiments the axis of the contact sensitive member 55 can pass within 10 mm of the last axis L1.

As best shown in FIG. 2B, the main body 90 can also include a display 43. The display 43 is depicted as being at a top-rear end of the main body 90, but can also be disposed at other positions. The display 43 can be disposed toward the rear of the main body 90 to prevent it from being covered by the scanning device 60, which can include an upper housing 80 on a top portion, as further discussed herein. The display 43 can provide feedback to a user, such as information regarding measurements that have been or should be acquired by the device, as operated by the user, as discussed herein. The display 43 can also provide other information, such as diagnostic information related to the PCMM 1 or the scanning device 60 like battery level, temperature, or other issues.

As best depicted in FIG. 3B, the main body 90 can further include a mounting portion 91, a recess 92, and a data port 93, configured to interact with a scanning device (depicted as a laser scanner) 60. The laser scanner 60, as best depicted in FIG. 3A, can include an upper housing 80, a laser 65, and a data port 101. As shown in FIG. 3, the laser scanner 60 can be configured to mount on the main body 90 as an auxiliary body (which can include different devices in other embodiments). The upper housing 80 can be shaped to match the mounting portion 91, and can accordingly be received by that mounting portion. The recess 92 can be shaped to receive the laser 65 when the mounting portion 91 receives the upper housing 80. Upon these interactions, the data ports 93, 101 can interact to pass information between the main body 90 and the laser scanner 60 (and accordingly further along the PCMM arm 1 as described above). The laser scanner 60 can further include a base-plate 75. The base-plate 75 can include a port 85 configured to receive the contact sensitive member 55 when the laser scanner 60 mounts to the main body 90.

The base plate 75 can also include a repeatable kinematic mount, where the laser scanner 60 can be removed and remounted to the main body 90 without tools (for example, in combination with a snap-lock mechanism). It can be remounted with a high level of repeatability through the use of a 3-point kinematic seat, including three kinematic mounting portions 94 on the base plate 75 (depicted as a pair of cylinders) and three kinematic mounting portions 104 on the main body 90 (depicted as rounded or spherical bodies that are received between the pair of cylinders). The mounting portions 94, 104 can be precisely-shaped to match each other to form a kinematic mounting that holds their angular position constant. Variations on this design can also be used, such as using different shapes or different numbers of mounting portions 94, 104, such as more than three sets of mounting portions, and tetrahedral holes instead of a pair of cylinders.

As best depicted in FIGS. 4A and 4B, a locking device 120 can be used to firmly secure the scanner 60 to the main body 90. The locking device 120 can include a port that receives the contact sensitive member 55 in a way similar to the port 85 on the scanner 60. In this way, the locking device 120 can be mounted such that the scanner 60 is between the locking device and the main body 90. The locking device 120 can include a pair of hooks that, upon rotation of a handle, rotate and hook onto handles on the main body 90 to hold the scanner 60 on the main body 90. A further rotation of the handle can urge the scanner 60 against the main body 90 to firmly secure the scanner 60 to the main body 90. Various resilient members that can resilient deform such as a spring (such as a wave spring or a coil spring), washers, and padded structures can be included between the scanner 60 and the main body 90, the scanner 60 and the locking device 120, or the locking device 120 and the main body 90. The resilient members can mechanically isolate these components, such that the locking pressure does not lead to deflections in any of the bodies, or allow deflections in one body to cause a deflection in another. Thus, for example, if the contact sensitive member 55 contacts a measured item causing it and the main body 90 to deflect, the mechanical isolation will reduce any coinciding deflection in the scanner 60. The resilient members can also optionally provide thermal insulation between the main body 90 and the scanner 60.

Other scanning devices can optionally have similar shapes as the laser scanner 60. For example, other scanning devices can include a base-plate 75 (or another body) that includes a port 85 configured to receive a contact sensitive member 55 (for example, through a hole in the body). Similarly, other scanning devices can include a light source (such as a laser, a projector, or a general light source) that can be received in a recess 92 in a manner similar to the laser 65. Further, in some embodiments the shape of the mounting portion 91 on the PCMM 1 can vary to accommodate other scanning devices. For example, in some embodiments the body of the main body 90 can be reduced to provide clearance for other components on scanning devices that might be mounted to the mounting portion 91. Examples of other devices mounted on the main body 90 (and received by the main body 90) are depicted in FIGS. 7, 8, and 9.

When the PCMM 1 is intended to provide accurate position data, the PCMM can be designed to minimize the errors at both the contact sensitive member 55 and at the non-contact coordinate detection device 60. The error of the coordinate acquisition member 50 can be reduced by minimizing the effect of the errors of the last three axes on both the contact sensitive member 55 and the scanning device 60. For example, as depicted the camera 70, the contact sensitive member 55, and the light source 65 can be directly integrated with the last axis L1. For example, as depicted the camera 70, contact sensitive member 55, and light source 65 can be generally collinear when viewing from the front (e.g. along axis L1), with the contact sensitive member 55 in the middle and aligned with the last axis L1. Further, as depicted the upper housing 80, contact sensitive member 55, and the light source 65 can be arranged generally parallel to the last axis L1. However, the camera 70 can optionally be oriented at an angle relative to the last axis L1.

Such arrangements can be advantageous in a number of ways. For example, in this arrangement the angular position of the elements about L1 can be approximately equal (with the exception of a 180 degree offset when on different sides of the last axis L1), simplifying data processing requirements. As another example, providing these elements aligned with the last axis L1 can facilitate counterbalancing the weight of these elements about the last axis, reducing error from possible deflection and easing movement about the axis. Even further, the error associated with the angle of rotation about the last axis L1 is amplified by the distance (such as the perpendicular distance) from the axis to a center of the pattern emitted by the light source 65 (such as a focal center of the light source). In this orientation, the distance is minimized. In some embodiments, the perpendicular distance from the center of the projected pattern to the last axis can be no greater than 35 mm. Notably, in other embodiments it may be desirable to move the light source 65 even closer to the last axis L1, such as by aligning it directly therewith (placing it where the contact sensitive member 55 is depicted in the figures). However, the accuracy of the contact sensitive member 55 is also partially dependent on its proximity to the last axis L1; and, as described below, some other advantages can arise from separating the light source 65 from the camera 70.

As further depicted, when the scanning device 60 mounts the main body 90, the contact sensitive member 55 and the scanning device can form a compact design. For example, the light source 65 and/or the camera 70 can extend past the one or both of the bearings 150, 151. In other embodiments, these elements can extend to the bearings, and not pass them. Generally, causing these elements to overlap reduces the necessary length of the coordinate acquisition member 50.

In some embodiments such compact designs can allow the coordinate acquisition elements to be closer to the second to last axis L2, as well as the last axis L1. Accordingly, the distance between the second to last axis L2 and the points of measurement (e.g. at the tip of the contact sensitive member 55 and/or at the focus of the camera 70) can be reduced. As the error in the angular position of the coordinate acquisition member 50 along the second to last axis L2 is amplified by these distances, this also reduces the error of the PCMM 1 in other ways. For example, the compact design can also reduce error related to the distance from the focus of the camera 70 to the third to last axis L3. Additionally, providing the elements of the coordinate acquisition member 50 closer to the second and third to last axes L2, L3 can reduce deflection, reducing error even further. In some embodiments the contact sensitive member 55 can be within 185 mm of the second and/or third to last axis L2, L3, and the focus of the camera 70 can be within 285 mm of the third to last axis. As yet another advantage to the compact design, the vertical height of the coordinate acquisition member 50 can be reduced, allowing measurement in tighter spots. In some embodiments the height can be no greater than 260 mm. Notably, as the coordinate acquisition member 50 in the depicted embodiment rotates about the last axis L1, the height can also represent a maximum length of the coordinate acquisition member 50.

In some embodiments, the scanning device 60 can include additional advantages. For example, the scanning device 60 can isolate the light source 65 from heat generated by the other parts of the PCMM arm 1. For example, as depicted in FIG. 3, a base plate 75 holds the light source 65 at one end and the camera 70 at the other, separated by the contact sensitive member 55. In some embodiments the base plate 75 can include a material with a low coefficient of thermal expansion such as Invar, Ceramic, or Carbon Fiber. Reducing thermal expansion can reduce changes in the position and orientation of the light source 65 and/or the camera 70, which could create problems such as introducing additional error into the measurements. Similarly, the base plate 75 can also include a material with a low thermal conductivity, hindering transmission of heat, for example, from the camera 70 to the light source 65 or PCMM 1.

As depicted, the camera 70 can be held in an upper housing 80 of the scanner 60, and in some embodiments the upper housing can include multiple cameras. In embodiments with multiple cameras, the cameras can be arranged on opposite sides of the last axis of rotation L1, optionally defining equal angular distance about the axis L1 between each of the two cameras and the light source 65. Alternatively, as shown in FIG. 11, the cameras can be arranged on opposite sides of the axis of rotation L1, symmetrically relative to a vertical plane passing through the last axis L1. In further embodiments, the angular distance between the cameras can be determined to balance the weight of the cameras, the light source, and any other components, about the last axis L1.

The upper housing 80 can also include materials such as aluminum or plastic. Additionally, the upper housing 80 can protect the camera 70 from atmospheric contaminants such as dust, liquids, ambient light, etc. Similarly, the light source 65 can be protected by the recess 92 of the main body 90. In some embodiments, the recess 92 can include a thermal isolation disc or plate with a low coefficient of thermal expansion and/or conductivity, protecting the light source from external heat and substantially preserving its alignment.

In many embodiments, the electronics 160 associated with the scanning device 60 can create a substantial amount of heat. As discussed above, various components can be protected from this heat with materials having low coefficients of thermal expansion and conductivity for example. As depicted, the electronics 160 can be positioned in the upper housing 80 of the scanning device 60.

However, in other embodiments the electronics 160 can be positioned further from the sensors 55, 60, such as in a completely separate housing. For example, in some embodiments the electronics 160 can be held by the scanning device 60 in a separate housing, also attached to the base plate 75. In other embodiments, the electronics 160 can be located further down the PCMM 1, such as in a rigid transfer member 20 or in the base 10. Moving the electronics 160 further down the PCMM 1 can reduce weight at the end of the arm, minimizing deflection of the arm. Similarly, in some embodiments the electronics 160 can be completely outside the PCMM 1, such as in a separate computer. Data from the sensors 55, 70 can be transmitted through the PCMM 1 on an internal cable in the arm, wirelessly, or by other data transmission methods. In some embodiments, data ports 93, 101 can include spring loaded pins such that no cables are externally exposed.

As another advantage of the depicted embodiment, the depicted layout of the system can use a smaller volume. The scanning device 60 can sometimes operate on a theory of triangulation. Accordingly, it may be desirable to leave some distance between the light source 65 and the camera 70. The depicted embodiment advantageously places the contact sensitive member 55 within this space, reducing the volume of the coordinate acquisition member 50. Additionally, the last axis L1 also passes through this space, balancing the system about the axis of rotation and reducing the coordinate acquisition member's 50 rotational volume. In this configuration, the combination of axis and scanning device can further be uniquely optimized to reduce weight, as the more compact design reduces deflection, and accordingly reduces the need for heavy-load bearing materials.

Many other variations on the methods and systems described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various algorithm steps described in connection with the embodiments disclosed herein can be implemented as electronic hardware, computer software, or combinations of both. To clearly illustrate this interchangeability of hardware and software, various illustrative steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative steps, components, and computing systems (such as devices, databases, interfaces, and engines) described in connection with the embodiments disclosed herein can be implemented or performed by a machine, such as a general purpose processor, a graphics processor unit, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor can also include primarily analog components. A computing environment can include any type of computer system, including, but not limited to, a computer system based on a microprocessor, a graphics processor unit, a mainframe computer, a digital signal processor, a portable computing device, a personal organizer, a device controller, and a computational engine within an appliance, to name a few.

The steps of a method, process, or algorithm, and database used in said steps, described in connection with the embodiments disclosed herein can be embodied directly in hardware, in a software module executed by a processor, or in a combination of the two. A software module, engine, and associated databases can reside in memory resources such as in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

1. A method of measuring various properties of an object, the method comprising:
mounting a first measuring device to an end of an articulated arm coordinate measuring machine;
measuring three-dimensional coordinates of a surface of an object using the first measuring device mounted to the end of the articulated arm coordinate measuring machine;
mounting a second measuring device to the end of the articulated arm coordinate measuring machine;
measuring a second property of the object using the second measuring device mounted to the end of the articulated arm coordinate measuring machine after the three-dimensional coordinates have been measured.

2. The method of claim 1, wherein the first measuring device is a non-contact coordinate detection device.

3. (canceled)

4. (canceled)

5. (canceled)

6. The method of claim 1, wherein the second property is a non-geometric property of the object.

7. The method of claim 1, wherein the second property is not a property that can be detected by a standard camera.

8. The method of claim 1, wherein the second property is not a geometric property of the surface of the object.

9. (canceled)

10. (canceled)

11. The method of claim 1, wherein the second measuring device is configured to detect voids or cracks below a surface of the object.

12. The method of claim 1, wherein the second measuring device is a spectral or hyperspectral imager.

13. (canceled)

14. (canceled)

15. The method of claim 1, further comprising the step of generating a model of the object using at least the measured three-dimensional coordinates prior to measuring the second property.

16. The method of claim 15, further comprising displaying to a user a portion of the object for which the second property has not yet been measured.

17. The method of claim 15, further comprising displaying to a user a suggested portion of the object to measure with the second measuring device.

18. The method of claim 15, further comprising displaying to a user a suggested position of the articulated arm coordinate measuring machine to measure the object in a region where the second property has not yet been measured.

19. The method of claim 15, further comprising displaying to a user portions of the object for which the second property has already been measured.

20. The method of claim 15, further comprising indicating to a user when all of a desired portion of the object has been measured with the second measuring device.

21. The method of claim 15, wherein the second measuring device is configured to generate a plurality of data over a two-dimensional area, and further comprising associating a data point in the two-dimensional area with a three-dimensional coordinate on the object.

22. (canceled)

23. A method of measuring various properties of an object, the method comprising:
measuring three-dimensional coordinates of a surface of an object using a coordinate measuring device;
mounting a second measuring device to the coordinate measuring device; and
measuring a second property of the object using the second measuring device mounted to the coordinate measuring device after the three-dimensional coordinates have been measured.

24. (canceled)

25. The method of claim 23, wherein the coordinate measuring device is a retroreflector associated with a laser tracker.

26. The method of claim 23, wherein the coordinate measuring device comprises a non-contact coordinate detection device.

27. (canceled)

28. (canceled)

29. (canceled)

30. The method of claim 23, wherein the second property is a non-geometric property of the object.

31. The method of claim 23, wherein the second property is not a property that can be detected by a standard camera.

32. The method of claim 23, wherein the second property is not a geometric property of the surface of the object.

33. (canceled)

34. (canceled)

35. The method of claim 23, wherein the second measuring device is configured to detect voids or cracks below a surface of the object.

36. The method of claim 23, wherein the second measuring device is a spectral or hyperspectral imager.

37. (canceled)

38. (canceled)

39. The method of claim 23, further comprising the step of generating a model of the object using the measured three-dimensional coordinates prior to measuring the second property.

40. The method of claim 39, further comprising displaying to a user a portion of the object for which the second property has not yet been measured.

41. The method of claim 39, further comprising displaying to a user a suggested portion of the object to measure with the second measuring device.

42. The method of claim 39, further comprising displaying to a user a suggested position of the coordinate measuring device to measure the object in a region where the second property has not yet been measured.

43. The method of claim 39, further comprising displaying to a user portions of the object for which the second property has already been measured.

44. The method of claim 39, further comprising indicating to a user when all of a desired portion of the object has been measured with the second measuring device.

45. The method of claim 39, wherein the second measuring device is configured to generate a plurality of data over a two-dimensional area, and further comprising associating a location in the two-dimensional data with a three-dimensional coordinate on the object.

46. (canceled)

47. A device configured to measure a surface geometry of an object and at least one other property of the object, the device comprising:
a coordinate measuring device configured to measure three-dimensional coordinate data of a surface of an object by at least measuring a position and orientation of a portion of the coordinate measuring device, the coordinate measuring device further comprising a mounting portion configured to receive a second measuring device such that the coordinate measuring device can measure a position and orientation of the second measuring device;
a second measuring device mounted to the mounting portion and configured to measure a property of the object different from the three-dimensional coordinate data of the surface of the object at a plurality of locations;
one or more processors configured to use the three-dimensional coordinate data of the surface of the object and measured positions and orientations of the second measuring device to associate data collected by the second measuring device with corresponding three-dimensional coordinates.

48. The device of claim 47, wherein the coordinate measuring device comprises an articulated arm coordinate measuring machine.

49. The device of claim 47, wherein the coordinate measuring device comprises a laser tracker.

50. (canceled)

51. (canceled)

52. (canceled)

53. The device of claim 47, wherein the property of the object different from the three-dimensional coordinate data of the surface of the object is a non-geometric property of the object.

54. The device of claim 47, wherein the property of the object different from the three-dimensional coordinate data of the surface of the object is not a property that can be detected by a standard camera.

55. (canceled)

56. (canceled)

57. The device of claim 47, wherein the second measuring device is configured to detect voids or cracks below a surface of the object.

58. The device of claim 47, wherein the second measuring device is a spectral or hyperspectral imager.

59. (canceled)

60. (canceled)

61. The device of claim 47, wherein the one or more processors are configured to generate a model of the object using the three-dimensional coordinates.

62. The device of claim 61, further comprising a display, wherein the one or more processors are configured to operate the display to indicate a portion of the object for which the property of the object different from the three-dimensional coordinate data of the surface of the object has not yet been measured.

63. The device of claim 61, further comprising a display, wherein the one or more processors are configured to operate the display to indicate a suggested portion of the object to measure with the second measuring device.

64. The device of claim 61, further comprising a display, wherein the one or more processors are configured to operate the display to indicate portions of the object where the property of the object different from the three-dimensional coordinate data of the surface of the object has already been measured.

65. The device of claim 61, wherein the one or more processors are configured to output a signal to a user when all of a desired portion of the object has been measured with the second measuring device.

66. (canceled)
